(19) United States
(12) Patent Application Publication
(10) Pub. No.: US 2016/0091755 A1
(43) Pub. Date: Mar. 31, 2016

(54) Optical Assembly for Transparent LCD Display Case

(71) Applicant: Manufacturing Resources International, Inc., Alpharetta, GA (US)

(72) Inventor: William Dunn, Alpharetta, GA (US)

(21) Appl. No.: 14/866,244

(22) Filed: Sep. 25, 2015

Related U.S. Application Data
(60) Provisional application No. 62/055,255, filed on Sep. 25, 2014.

(51) Int. Cl. G02F 1/1335; A47F 3/00; F21V 8/00

(52) U.S. Cl. CPC G02F 1/133528; G02B 6/0073; A47F 3/005; A47F 3/002

(57) ABSTRACT

The exemplary embodiments herein provide a transparent LCD assembly having a liquid crystal cell with a front and rear polarizer. A light guide is preferably placed behind the LC cell and contains a plurality of LED positioned along an edge of the light guide. An additional polarizer may be placed behind the light guide and preferably bonded to the rear surface of the light guide. A front and rear glass may be used to surround the internal components. The additional polarizer can also be placed on the front or rear surfaces of the rear glass.

### CROSS-REFERENCE TO RELATED APPLICATIONS

This application claims priority to U.S. Application No. 62/055,255, filed on Sep. 25, 2014 which is herein incorporated by reference in its entirety.

### TECHNICAL FIELD

The exemplary embodiments relate generally to transparent liquid crystal displays and their use with display cases.

### BACKGROUND OF THE ART

It has been found that extended periods of illumination from certain wavelengths of light can break down some of the components in found in certain types of beverages, specifically alcoholic beverages such as beer. When using bright backlighting for transparent liquid crystal displays, illumination of the products within the display case can become a difficult issue to resolve, as high levels of lighting are highly desirable.

### SUMMARY OF THE EXEMPLARY EMBODIMENTS

Exemplary embodiments provide an assembly of various layers, including polarizing layers which permit light to transmit through the LCD without allowing significant amounts of illumination to enter the display case cavity containing any beverages or other products which may be susceptible to extended illumination.

The foregoing and other features and advantages of the present invention will be apparent from the following more detailed description of the particular embodiments, as illustrated in the accompanying drawings.

### BRIEF DESCRIPTION OF THE DRAWINGS

A better understanding of an exemplary embodiment will be obtained from a reading of the following detailed description and the accompanying drawings wherein identical reference characters refer to identical parts and in which:

FIG. 1 is a side view of the various layers within an exemplary embodiment.

### DETAILED DESCRIPTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein

Generally speaking, if unpolarized light is sent to the shelves then it remains unpolarized after reflection from the products until is strikes the rear (vertical) polarizer on the LC cell, after which a maximum of ½ (typically ˜45%) of this light passes through the rear-polarizer; the other ½ (typically ˜55%) is absorbed. So while the products are being bombarded by unpolarized light only ½ (or typically ˜45%) of this light, after reflection, has any chance of making it through the rear polarizer and then to the outside world. So the product is being unnecessarily exposed to higher levels of light.

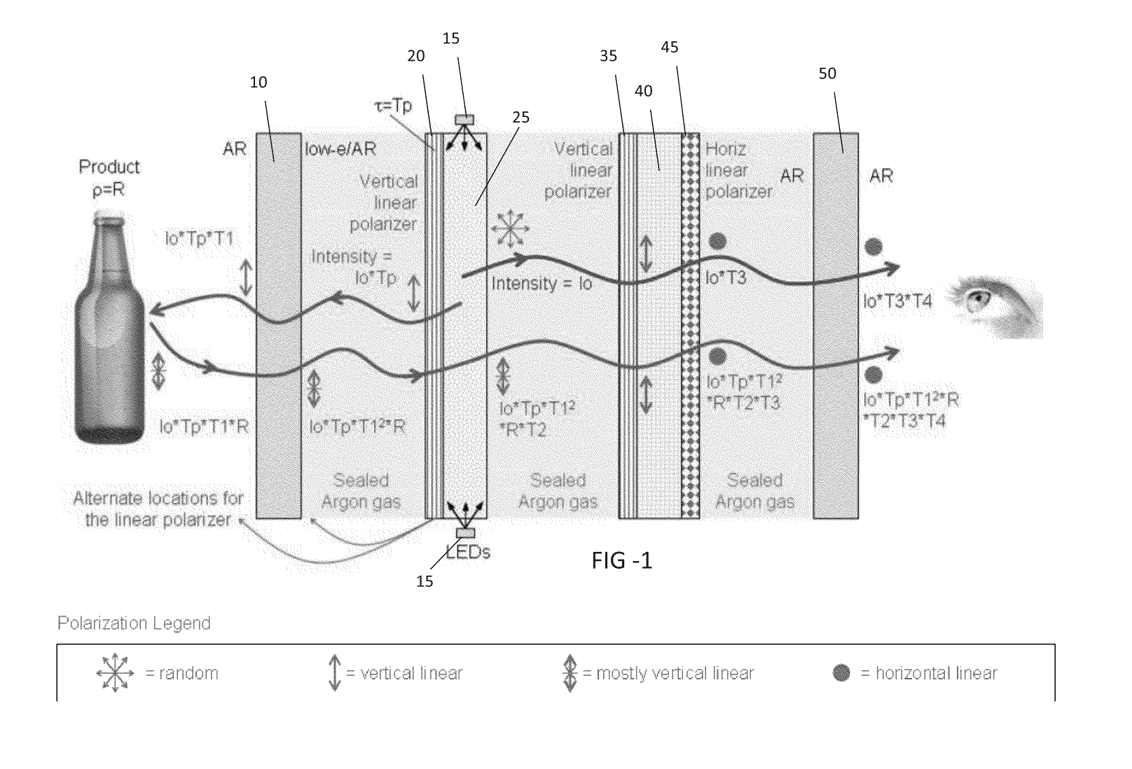

FIG. 1 is a side view of the various layers within an exemplary embodiment. An LC cell 40 and light guide 25 are placed between a front glass 50 and a rear glass 10. Preferably, the rear glass 10 would have an antireflective (AR) coating on the rear surface (facing the products) and a low-e/AR coating on the front surface (facing an intended observer). Also preferably, the front glass 50 would have an AR coating on the front and rear surfaces. The front glass 50 and rear glass 10 should gaseously seal the internal components when used with a cooler/refrigerator application, and preferably contain argon, but this is not required. The LC cell 40 is preferably sandwiched in between a rear polarizer 35 and a front polarizer 45, which generally are oriented vertical and horizontal respectively, but this is not required as other embodiments may reverse the two.

A plurality of LEDs 15 are preferably placed along at least one edge of the light guide 25 and should be placed along opposing edges. The additional polarizer 20 can be placed in several locations: (1) as shown on the rear surface of the light guide 25, (2) on the front surface of the rear glass 10, or (3) on the rear surface of the rear glass 10.

Here, the illumination exiting the rear of the light guide 25 can be pre-polarized, by placing the additional linear polarizer film 20 between the lightguide 25 and the products—3 potential locations are shown below, all are generally equivalent and could be switched depending on the manufacturing techniques being used. This additional polarizer 20 should preferably be oriented in the same direction as the rear polarizer 35 on the LC cell 40, labeled ‘vertical’ below, but it could be horizontal if the LC polarizer is horizontal.

The additional linear polarizer 25 has been discovered to attenuate the amount of light hitting the products by at least ½ (typically by ˜55%). After reflecting from the products the light is still mostly polarized (it has been generally measured ˜85% polarized), and thus when this light reaches the rear polarizer on the LC cell it is predominately transmitted. From outside the display case and LCD, the products on the shelves appear 85% as bright compared to the previous approach (virtually imperceptible), yet the light actually hitting the products is only ˜45% as strong, resulting in at least a 2.2× improvement in product shelf life.

Talking specifically regarding beer in amber-colored bottles, it is typically the wavelengths below ˜455 nm (deep Blue to UV) that cause the most problems. It turns out that the pre-polarizer approach provides extra optical attenuation in this wavelength range, and that the embodiments herein can actually realize a ˜3× improvement in product shelf life.

Having shown and described a preferred embodiment of the invention, those skilled in the art will realize that many variations and modifications may be made to affect the described invention and still be within the scope of the claimed invention. Additionally, many of the elements indicated above may be altered or replaced by different elements which will provide the same result and fall within the spirit of the claimed invention. It is the intention, therefore, to limit the invention only as indicated by the scope of the claims.

I claim:

1. A transparent LCD assembly comprising:
an LC cell having a front and rear surface;
a first linear polarizer placed on the front surface of the LC cell;
a second linear polarizer placed on the rear surface of the LC cell;
a light guide positioned behind the LC cell; and
a third linear polarizer positioned behind the light guide.

2. The transparent LCD assembly of claim 1 wherein:
the third linear polarizer is bonded to a rear surface of the light guide.

3. The transparent LCD assembly of claim 1 further comprising:
a front glass positioned in front of the LC cell; and
a rear glass positioned behind the light guide.

4. The transparent LCD assembly of claim 3 wherein:
the third linear polarizer is bonded to a rear surface of the rear glass.

5. The transparent LCD assembly of claim 3 wherein:
the third linear polarizer is bonded to a front surface of the rear glass.

6. The transparent LCD assembly of claim 1 wherein:
the third linear polarizer is oriented vertically.

7. The transparent LCD assembly of claim 1 further comprising:
a plurality of LEDs positioned along an edge of the light guide.

8. The transparent LCD assembly of claim 3 further comprising:
an antireflective coating on the front glass; and
an antireflective coating on the rear glass.

9. The transparent LCD assembly of claim 3 wherein:
the LC cell and light guide are gaseously sealed between the front and rear glass.

10. The transparent LCD assembly of claim 9 wherein:
argon is gaseously sealed between the front and rear glass.

11. A transparent LCD assembly comprising:
an LC cell having a first and second polarizer;
a light guide positioned behind the LC cell and having a plurality of LEDs along at least one edge of the light guide; and
a third polarizer placed behind the light guide.

12. The transparent LCD assembly of claim 11 wherein:
the third linear polarizer is bonded to a rear surface of the light guide.

13. The transparent LCD assembly of claim 11 wherein:
the third linear polarizer is bonded to a rear surface of the light guide.

14. The transparent LCD assembly of claim 11 further comprising:
a front glass positioned in front of the LC cell; and
a rear glass positioned behind the light guide.

15. The transparent LCD assembly of claim 14 wherein:
the third linear polarizer is bonded to a rear surface of the rear glass.

16. The transparent LCD assembly of claim 14 wherein:
the third linear polarizer is bonded to a front surface of the rear glass.

17. The transparent LCD assembly of claim 3 further comprising:
an antireflective coating on the front glass; and
an antireflective coating on the rear glass.

18. A transparent LCD assembly comprising:
an LC cell having a first and second polarizer;
a light guide positioned behind the LC cell and having four edges and a rear surface;
a plurality of LEDs positioned along at least one edge of the light guide;
a third polarizer bonded to the rear surface of the light guide; and
a front and rear glass which gaseously seal the LC cell, light guide, first polarizer, second polarizer, and third polarizer between the front and rear glass.

19. The transparent LCD assembly of claim 18 further comprising:
an antireflective coating on the front glass; and
an antireflective coating on the rear glass.

20. The transparent LCD assembly of claim 18 wherein:
the front and rear glass gaseously seal argon.
